(19) United States
(12) Patent Application Publication
(10) Pub. No.: US 2004/0260038 A1
(43) Pub. Date: Dec. 23, 2004

(54) Maleic acid derivative and curable composition containing the same

(76) Inventor: Wonmun Choi, Kanagawa (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/493,232

(22) PCT Filed: Oct. 31, 2002
(86) PCT No.: PCT/JP02/11369

(30) Foreign Application Priority Data
Nov. 6, 2001 (JP) 2001-340779
Dec. 14, 2001 (JP) 2001-381198
Dec. 14, 2001 (JP) 2001-381199

(51) Int. Cl. C08G 59/14

(52) U.S. Cl. 525/533

(57) ABSTRACT

This invention provides a maleic acid derivative produced by reacting a compound having at least one thiol group in one molecule with a maleic acid compound, and also, a curable composition containing such maleic acid derivative. The maleic acid derivative of the present invention is thermally dissociatable. The curable composition utilizing this maleic acid derivative for the curing agent can be used as a thermally dissociatable material.

### TECHNICAL FIELD

This invention relates to a novel maleic acid derivative and a curable composition containing such maleic acid derivative. To be more specific, this invention relates to a maleic acid derivative produced by reacting a compound having at least one thiol group in its molecule with maleic acid, and a thermally dissociatable curable composition containing such maleic acid derivative.

### BACKGROUND ART

A curing agent is a compound used for crosslinking a thermosetting resin, or promoting or regulating the curing reaction, and the type and amount of the curing agent used varies depending on the conditions of the curing, intended application of the product, and the like even if the resin to be cured were the same. A typical room temperature curing agent used when a phenol resin is used as a coating composition, an adhesive, or the like is an aromatic sulfonic acid, and an amine or a polyamide is used for the curing agent in the case of an epoxy resin.

In the case of epoxy resin, an acid anhydride is also used for the curing agent, and an acid anhydride has long pot life, and when it is used for the curing of the epoxy resin, the resulting cured product exhibits excellent electric properties, mechanical properties, chemical resistance, and the like. Since epoxy resin is a material widely used as an electric insulating material and other materials, if a new curing agent using an acid anhydride can be developed, the thus developed curing agent can be used not only for the epoxy resin but also for a wide variety of thermosetting resins. Then, the resulting cured products are expected to enjoy improved physical properties.

A compound which has two or more thiol groups in its molecule will readily cure when a metal oxide or an amine compound is used as a catalyst. Since thiol group readily reacts with epoxy group, isocyanate group, or the like to promote polymerization, it is widely used in sealants, coating compositions, and adhesives.

In the meanwhile, waste pollution, and in particular, plastic pollution has become a serious problem in relation to the issue of global environment. Plastics have a tradition that they have been developed in search for a highly durable material which is hardly decomposed, and today, this durability has ironically become the problem.

The products produced from a curable composition by using the curing agents as described above are not exception. In view of such situation, attempts have been made to develop biodegradable polymers, photodegradable polymers, and the like.

In spite of such attempts, no curing agent has been obtained that will produce a cured product having improved physical properties as well as thermal dissociatability. A thermally decomposable polymer is recyclable after decomposition, and use of such thermally decomposable polymer should be highly desirable. In view of the situation as described above, the inventors of the present invention have developed a polymer by using a thermally reversible reaction. A polymer material which is thermally dissociatable as described above is believed to be also useful as a thermal recording material or a heat storage material which stores heat by heat budget.

### DISCLOSURE OF THE INVENTION

In view of the situation as described above, an object of the present invention is to provide a novel curing agent which has thermal dissociation properties, and a polymer material which can be used as a thermally dissociatable material produced by using such curing agent, namely, a thermally dissociatable curable composition.

The inventors of the present invention carried out an extensive investigation to attain the object as described above, and in the course of such investigation, the inventors found that when a maleic acid derivative produced by reacting particular compounds is reacted with a compound which has a group capable of reacting with such maleic acid derivative, the cured product which is the reaction product would be a thermally dissociatable cured product. The inventors of the present invention has completed the present invention as described below on the bases of the finding as described above. Accordingly, the present invention provides the maleic acid derivative of (1).

(1) A maleic acid derivative produced by reacting a compound having at least one thiol group in one molecule, and a maleic acid compound.

This invention also provides the maleic acid derivative of (2) as a first preferred embodiment of the maleic acid derivative of (1).

(2) A maleic acid derivative represented by the following formula (1) or (2):

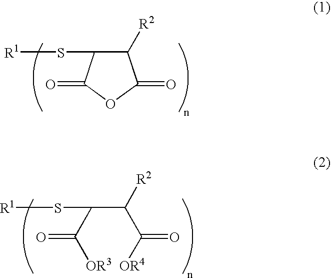

wherein n is an integer of 1 to 10; R¹ is an optionally substituted organic group containing 2 to 20 carbon atoms; R² is an optionally substituted alkyl group containing 2 to 10 carbon atoms, hydrogen atom, or a halogen atom; R³ and R⁴ are independently an optionally substituted alkyl group containing 2 to 20 carbon atoms or hydrogen atom.

This invention also provides the thiol compound of (3) as a second preferred embodiment of the maleic acid derivative of (1).

(3) A thiol compound produced by reacting a compound having at least two thiol groups in one molecule and a bismaleimide compound.

The thiol compound of (3) is preferably the thiol compound of (4).

(4) A thiol compound represented by the following formula (3):

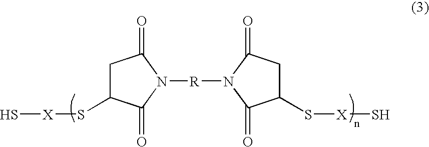

wherein n is an integer of 1 to 10; R is an optionally substituted noncyclic aliphatic group containing 1 to 24 carbon atoms, an optionally substituted cyclic aliphatic group containing 5 to 18 carbon atoms, an optionally substituted aromatic group containing 6 to 18 carbon atoms, or an optionally substituted alkyl aromatic group containing 7 to 24 carbon atoms, said group R optionally containing at least one hetero atom selected from the group consisting of SO₂, O, N, and S; and X is an optionally substituted organic group containing 2 to 24 carbon atoms.

This invention also provides the maleimide compound of (5) as a third preferred embodiment of the maleic acid derivative of (1).

(5) A maleimide compound having active hydrogen produced by reacting a compound having at least one thiol group, and at least one substituent selected from hydroxyl group, amino group, and carboxyl group in one molecule, and a bismaleimide compound.

The maleimide compound of (5) is preferably the maleimide compound of (6).

(6) A maleimide compound having active hydrogen represented by the following formula (4):

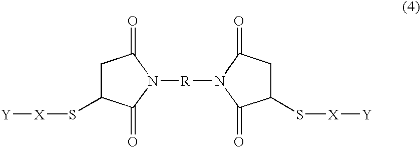

wherein; R is an optionally substituted noncyclic aliphatic group containing 1 to 24 carbon atoms, an optionally substituted cyclic aliphatic group containing 5 to 18 carbon atoms, an optionally substituted aromatic group containing 6 to 18 carbon atoms, or an optionally substituted alkyl aromatic group containing 7 to 24 carbon atoms, said group R optionally containing at least one hetero atom selected from the group consisting of SO₂, O, N, and S; X is an optionally substituted organic group containing 2 to 24 carbon atoms; and Y is hydroxyl group, amino group, or carboxyl group.

This invention also provides curable compositions of (7) to (10) wherein the maleic acid derivatives of the present invention are used.

(7) A curable composition comprising at least one member selected from the maleic acid derivative of the above (1) or (2), the thiol compound of the above (3) or (4), and the maleimide compound of the above (5) or (6); and a compound having a functional group capable of reacting with the maleic acid derivative, the thiol compound, or the maleimide compound.

(8) A curable composition according to the above (7) wherein said compound having a functional group capable of reacting with the maleic acid derivative has at least one functional group selected from amino group, hydroxyl group, thiol group, and epoxy group.

(9) A curable composition according to the above (7) or (8) wherein said compound having a functional group capable of reacting with the maleic acid derivative is an epoxy resin having epoxy group or an epoxy-modified compound.

(10) A curable composition according to the above (7) characterized in that said functional group capable of reacting with the thiol compound is at least one functional group selected from isocyanate group, epoxy group, carbonate group, ester group, vinyl group, oxazoline group, and maleic group.

(11) A curable composition according to the above (7) characterized in that said functional group capable of reacting with the maleimide compound is at least one functional group selected from isocyanate group, epoxy group, maleic group, carbonate group, silyl group, ester group, and oxazoline group.

(12) A curable composition according to any one of the above (7) to (11) wherein cured product produced by curing said curable composition is thermally dissociatable.

### BEST MODE FOR CARRYING OUT THE INVENTION

Next, the present invention is described in detail.

The maleic acid derivative of the present invention is produced by reacting a compound having at least one thiol group in one molecule and a maleic acid compound.

Typical examples of the compound having at least one thiol group in one molecule include ethanethiol, 1-propanethiol, 2-methyl-l-propanethiol, 2-methyl-2-propanethiol, 1-butanethiol, 2-butanethiol, 2-methyl-2-butanethiol, 2-methyl-1-butanethiol, 1-hexanethiol, 1-heptanethiol, 1-decanethiol, 1-dodecanethiol, n-hexadecanethiol, tert-hexadecanethiol, n-octadecanethiol, cyclopentanethiol, cyclohexanethiol, benzenethiol (thiophenol), 2,4-dimethylbenzenethiol, 2,5-dimethylbenzenethiol, 2-naphthalenethiol, 2-pyridinethiol, 4-pyridinethiol, 4-bromobenzenethiol, 3-chlorobenzenethiol, 4-chlorobenzenethiol, 2-fluorobenzenethiol, 3-fluorobenzenethiol, 4-fluorobenzenethiol, 3,4-dichlorobenzenethiol, 2,3-dichlorobenzenethiol, 2,6-dichlorobenzenethiol, 3,5-dichlorobenzenethiol, 2,4-dichlorobenzenethiol, 3-methoxybenzenethiol, 4-methoxybenzenethiol, and 4-nitrothiophenol.

Typical examples of the thiol compound which has hydroxyl group include 2-mercaptoethanol, 1-mercapto-2-propanol, 3-mercapto-1-propanol, 3-mercapto-1,2-propanediol, dithiothreitol, 2-mercapto-3-butanol, 2,3-dimercapto-1-propanol, 11-mercapto-1-undecanol, 4-mercapto-phenol, and 2,8-dimercapto-6-hydroxypurine.

Typical examples of the thiol compound which has amino group include 2-amino-ethanethiol, 2-amino-thiophenol, 3-amino-thiophenol, 4-amino-thiophenol, 2,4-diamino-6-mercaptopyrimidine, 2-amino-4-ethylamino-6-mercaptopyrimidine, 2-amino-6-mercaptopurine, and 2-amino-9-butyl-mercaptopurine.

Typical examples of the thiol compound which has carboxyl group include mercaptoacetic acid, 2-mercaptopropionic acid, 3-mercaptopropionic acid, mercaptosuccinic acid, 2-mercaptonicotinic acid, thiosalicylic acid (o-mercaptobenzoic acid), and 11-mercaptoundecanoic acid.

Typical examples of the compound having at least two thiol groups in one molecule include methanedithiol, 1,3-butanedithiol, 1,4-butanedithiol, 2,3-butanedithiol, 1,2-benzenedithiol, 1,3-benzenedithiol, 1,4-benzenedithiol, 1,10-decanedithiol, 1,2-ethanedithiol, 1,6-hexanedithiol, 1,9-nonanedithiol, 1,8-octanedithiol, 1,5-pentanedithiol, 1,2-propanedithiol, 1,3-propanedithiol, toluene-3,4-dithiol, 3,6-dichloro-1,2-benzenedithiol, 1,5-naphthalenedithiol, 1,2-benzenedimethanethiol, 1,3-benzenedimethanethiol, 1,4-benzenedimethanethiol, 4,4′-thiobisbenzenethiol, 1,3,4-thiadiazole-2,5-dithiol, 1,8-dimercapto-3,6-dioxaoctane, 1,5-dimercapto-3-thiapentane, 1,3,5-triazine-2,4,6-trithiol (trimercapto-triazine), 2-di-n-butylamino-4,6-dimercapto-s-triazine, trimethylolpropanetris(β-thiopropionate), trimethylolpropanetris(thioglycolate), and polythiol (thiokol or thiol-modified polymers (resin, rubber, or the like)).

Next, the maleic acid compound may be any maleic acid compound which reacts with the compound having thiol group. Typical such maleic acid compounds include maleic acid; methylmaleic acid, and other maleic acid having an alkyl group; maleic monoamide; monomethyl maleate, monoethyl maleate, n-butyl maleate, mono(2-ethylhexyl) maleate, and other monoalkyl maleates; and maleic anhydride, and methylmaleic anhydride which are anhydrides of such maleic acid compound. The maleic acid compound may also be a maleimide compound, and in such a case, the maleimide compound is preferably a bismaleimide compound. Exemplary bismaleimide compounds include 1,2-bismaleimide ethane, 1,6-bismaleimide hexane, N,N′-1,2-phenylenebismaleimide, N,N′-1,3-phenylenebismaleimide, N,N′-1,4-phenylenebismaleimide, N,N′-1,4-phenylene-2-methyl-dimaleimide, N,N′-(1,1′-biphenyl-4,4′-diyl)bismaleimide, N,N′-(3,3′-dimethyl-1,1′-biphenyl-4,4′-diyl)bismaleimide, 4,4′-diphenylmethanebismaleimide, N,N′-(methylene di(2-chloro-4,1-phenylene))bismaleimide, bis(3-ethyl-5-methyl-4-maleimidephenyl)methane (product name: BMI-70, manufactured by K•I Chemical Industry Co., Ltd.), 2,2-bis(4-(4-maleimidephenoxy)phenyl)propane, N,N′-(sulfonylbis(1,3-phenylene))dimaleimide, and N,N′-(4,4′-trimethyleneglycol dibenzoate)bismaleimide. Also included are maleimide-modified polymer compounds (resin, rubber, or the like).

The maleic acid derivative of the present invention may be any compound which is produced by reacting the compound containing at least one thiol group in one molecule and the maleic acid compound as described above.

The maleic acid derivative of the present invention according to the first preferred embodiment is the maleic acid derivative represented by the following formula (1) or (2) produced by reacting the above-described compound containing at least one thiol group in one molecule, which is more preferably a compound containing at least two thiol groups in one molecule, with the above-described maleic acid compound which is not the maleimide compound, namely, a maleic acid compound selected from the maleic acid and those having an alkyl group, maleic monoamides, monoalkyl maleates, and anhydrides thereof.

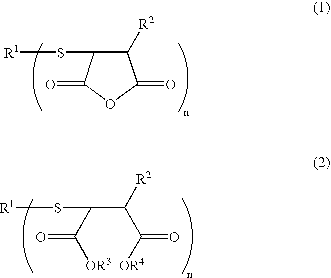

To be more specific, the maleic acid derivative represented by the above formula (1) or (2) is produced by the reaction as described below. The maleic acid derivative represented by the above formula (1) or (2), however, is not limited to those produced by such reaction.

This reaction is preferably allowed to take place by adding the maleic acid compound at an amount equivalent to the number of thiol groups included in one molecule of the compound having thiol group (for example, in the case of the compound containing two thiol groups, the maleic acid compound is added at an amount of 2 equivalents) without using any solvent or in an organic solvent at room temperature to 100° C. for 2 to 24 hours with stirring. The organic solvent used may be any organic solvent as long as the maleic acid compound and the compound containing thiol group as described above are both soluble in the organic solvent, and the preferable organic solvents include methyl ethyl ketone, toluene, and N,N-dimethylformamide.

After the completion of the reaction, the mixture is concentrated by removing the organic solvent at 50 to 100° C. under a reduced pressure to thereby obtain the maleic acid derivative represented by the above formula (1) or (2).

Of the maleic acid compounds as mentioned above, when an anhydride such as maleic anhydride, or methylmaleic anhydride is reacted with the compound having thiol group, the maleic acid derivative produced is the one represented by the formula (1), and when a maleic acid or an alkyl group, a maleic monoamide, or a monoalkyl maleate is reacted with the compound having thiol group, the maleic acid derivative produced is the one represented by the formula (2).

It is also to be noted that, of the thiol compounds as mentioned above, the thiol compound is preferably a polythiol containing at least two thiol groups in one molecule, and more preferably, a compound having an aromatic thiol group (hereinafter also referred to as an aromatic thiol), or a heterocyclic compound containing thiol group (hereinafter also referred to as a heterocyclic thiol) in order to produce the maleic acid derivative represented by the above formula (1) or (2) by the reaction as described above, since use of such thiol compound is effective in making use of the thermal dissociation property as will be described below. To be more specific, the thiol compound is preferably 1,3,4-thiadiazole-2,5-dithiol, 2-di-n-butylamino-4,6-dimercapto-s-triazine, or trimercapto-triazine.

Among such thiol compound, use of 1,3,4-thiadiazole-2,5-dithiol or 2-di-n-butylamino-4,6-dimercapto-s-triazine is preferable since these compounds which are solid and free from odor are convenient to use, and these compounds undergo fast reaction with maleic anhydride, and therefore, convenient for use in the curable composition as described below.

Among the maleic acid compounds as mentioned above, it is preferable to react maleic acid, maleic anhydride, or maleic mono-n-butylate with the compound having thiol group for economic reason.

In the above formulae (1) and (2), n is preferably an integer of 1 to 10, and more preferably an integer of 2 to 5. The above formulae (1) and (2) is more preferably a maleic acid derivative wherein n is 2. In this reaction, n is determined by the number of thiol groups in the compound having at least one thiol group in one molecule as described. For example, when the compound having the thiol group is the one having one thiol group in one molecule, n in the above formulae (1) and (2) will be 1, while n in the above formulae (1) and (2) will be 2 when the compound having the thiol group is the one having two thiol groups in one molecule. Accordingly, the maleic acid derivative of the above formula (1) or (2) wherein n is 2 is preferably produced by the reaction between the compound having two thiol groups in one molecule and the maleic acid compound.

In the above formulae (1) and (2), R¹ is preferably an optionally substituted organic group containing 2 to 20 carbon atoms, and more preferably an optionally substituted organic group containing 2 to 10 carbon atoms. The organic group is an alkyl group, a cycloalkyl group, an aryl group, or the like which is optionally substituted with at least one atomic group selected from a cycloalkyl group, an alkoxyl group, a cycloalkoxy group, an aryl group, an aryloxy group, an alkanoyloxy group, an aralkyloxy group, or a halogen atom; and preferably, an aliphatic hydrocarbon group, an aromatic group, a heterocyclic group, or a substituent formed by combining these substituents. R¹ is preferably an aromatic group or a heterocyclic group in view of the ease of thermal dissociation. In the reaction, R¹ is determined by the compound having at least one thiol group in one molecule, and therefore, when the R¹ in the formula (1) or (2) should be an aromatic group or a heterocyclic group, the compound having at least one thiol group in one molecule should be an aromatic thiol or a heterocyclic thiol as described above.

Next, R² is preferably an alkyl group which is optionally substituted with a substituent containing 2 to 10 carbon atoms, hydrogen atom, or a halogen atom, and more preferably hydrogen atom. R³ and R⁴ are preferably an alkyl group which is optionally substituted with a substituent containing 2 to 20 carbon atoms or hydrogen atom, and more preferably, an alkyl group which is optionally substituted with a substituent containing 2 to 10 carbon atoms or hydrogen atom.

In view of the situation as described above, typical maleic acid derivatives represented by the above formulae (1) and (2) are maleic anhydride addition products of a dithiol and maleic monoester addition products of a dithiol, and exemplary maleic acid derivatives include compounds represented by the following formulae (5), (6), and (7) which are synthesized in Examples 1 to 3 as described below.

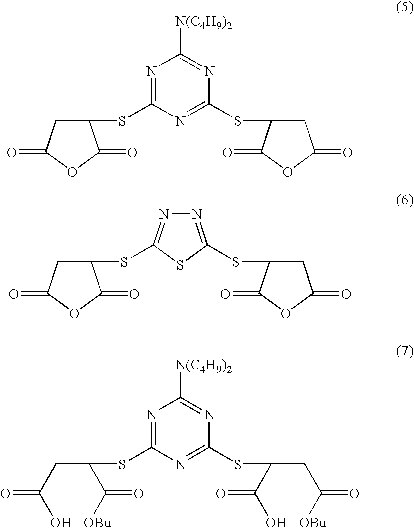

The maleic acid derivative of the present invention according to the second preferred embodiment is the thiol compound represented by the following formula (3) produced by reacting the compound having at least two thiol groups in one molecule and a bismaleimide compound.

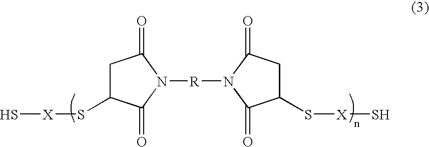

To be more specific, the thiol compound represented by the above formula (3) is produced by the reaction as described below. The thiol compound represented by the above-described formula (3), however, is not limited to those produced by such reaction.

This reaction is preferably conducted by adding 1.5 to 2.0 equivalents of the compound having at least two thiol groups in one molecule to the bismaleimide compound, and stirring the mixture in an organic solvent at room temperature to 150° C. for 1 to 24 hours. The organic solvent used may be any solvent as long as both the bismaleimide compound and the compound having at least two thiol groups in one molecule are soluble in the solvent, and exemplary such solvents include acetone, methyl ethyl ketone, N-methyl-2-pyrrolidone, tetrahydrofuran, and N,N-dimethylformamide. The preferred are methyl ethyl ketone and N,N-dimethylformamide since they exhibit high solvency.

After the completion of the reaction, the mixture is concentrated by removing the organic solvent under a reduced pressure to obtain the thiol compound represented by the above formula (3).

It is to be noted that, of the compounds having at least two thiol groups in one molecule as mentioned above, the preferred is an aromatic thiol or a heterocyclic thiol having at least two thiol groups in one molecule in order to produce the thiol compound represented by the formula (3) by the above-described reaction, since use of such thiol compound is effective in making use of the thermal dissociation property as will be described below. To be more specific, the compound having at least two thiol groups in one molecule is preferably 2,5-dimercapto-1,3,4-thiadiazole, 2-di-n-butylamino-4,6-dimercapto-s-triazine, and trimercapto-triazine.

Use of 2,5-dimercapto-1,3,4-thiadiazole and 2-di-n-butylamino-4,6-dimercapto-s-triazine are also preferable since these compounds are solid and odorless and easy to handle, and these compounds also enjoy high curing speed, and therefore, advantageous when incorporated in the curable composition described below.

With regard to the bismaleimide compound, of the bismaleimide compounds mentioned above, use of 1,6-bismaleimide hexane, 1,2-bismaleimide ethane, or 4,4′-diphenylmethanebismaleimide is preferable for economic reason.

In the above formula (3), n is preferably an integer of 1 to 5, and more preferably an integer of 1 to 3. More preferably, the compound of the above formula (3) is a thiol compound wherein n is 1 or 2, and most preferably, a thiol compound wherein n is 1. In this reaction, n is determined by the mixing ratio (molar ratio) of the compound having at least two thiol groups in one molecule and the bismaleimide compound. For example, when an equimolar amount of the compound having at least two thiol groups in one molecule is added to the bismaleimide compound, the reaction that takes place will be polymerization and n will be greater than 10. On the other hand, when twice the molar amount of the compound having at least two thiol groups in one molecule is added to the bismaleimide compound for reaction, n will be 1 or 2. Accordingly, the thiol compound wherein n in the above formula (3) is 1 or 2 is preferably produced by reacting twice the molar amount of the compound having at least two thiol groups in one molecule with the bismaleimide compound.

In the above formula (3), R represents an optionally substituted noncyclic aliphatic group containing 1 to 24 carbon atoms, an optionally substituted cyclic aliphatic group containing 5 to 18 carbon atoms, an optionally substituted aromatic group containing 6 to 18 carbon atoms, or an optionally substituted alkylaromatic group containing 7 to 24 carbon atoms, and R may contain at least one hetero atom selected from the group consisting of SO₂, O, N, and S.

When R has a substituent, the substituent may be any substituent as long as the reaction of the present invention is not affected by the substituent.

In this reaction, R is determined by the structure of the above-described bismaleimide compound. For example, when the bismaleimide compound is 1,6-bismaleimide hexane, R in the above formula (3) is hexyl group, and when the bismaleimide compound is N,N′-1,4-phenylenedimaleimide, R in the above formula (3) will be phenyl group. Accordingly, the maleimide compound wherein R in the above formula (3) is the particular group as described above is preferably obtained by reacting the bismaleimide compound having an optionally substituted noncyclic aliphatic group containing 1 to 24 carbon atoms, an optionally substituted cyclic aliphatic group containing 5 to 18 carbon atoms, an optionally substituted aromatic group containing 6 to 18 carbon atoms, or an optionally substituted alkylaromatic group containing 7 to 24 carbon atoms with the compound having at least two thiol groups in one molecule.

In the above formula (3), X represents an optionally substituted organic group containing 2 to 24 carbon atoms, and X preferably contains at least one hetero atom selected from the group consisting of SO₂, O, N, and S. The term organic group used herein designates an alkyl group, a cycloalkyl group or an aryl group which is optionally substituted with at least one atomic group selected from the group consisting of a cycloalkyl group, an alkoxyl group, a cycloalkoxy group, an aryl group, an aryloxy group, an alkanoyloxy group, an aralkyloxy group, and a halogen atom. The organic group is preferably an oxyalkyl group, an aliphatic hydrocarbon group, or an aromatic group, heterocyclic group, or a substituent formed by combination of these groups. For the convenience of thermal dissociation, the organic group is either an aromatic group or a heterocyclic group. When the organic group has a substituent, the substituent may be any substituent as long as the reaction of the present invention is not affected by the substituent. The preferred, however, are an alkyl group and a halogen group.

In this reaction, X is determined by the compounds having at least two thiol groups in one molecule. Accordingly, when X in the above formula (3) should be an aromatic group or a heterocyclic group, an aromatic thiol or a heterocyclic thiol is used for the compounds having at least two thiol groups in one molecule.

In view of the situation as described above, examples of the thiol compounds represented by the formula (3) include the compounds represented by the following formulae (8), (9), (10) and (11). It is to be noted that the compound represented by the following formula (11) corresponds to the one which was synthesized in the Example 4. Of the compounds as mentioned above, the compounds represented by the formula (9), (10) and (11) are the preferred.

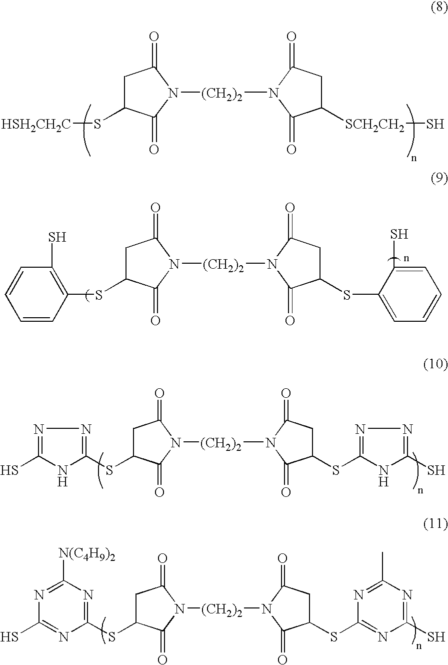

In the above formulae (8) to (11), n is an integer of 1 to 10.

The maleic acid derivative of the present invention according to the third preferred embodiment is a maleimide compound having active hydrogen produced by reacting a compound having at least one thiol group and at least one substituent selected from the group consisting of hydroxyl group, amino group, and carboxyl group in one molecule and a bismaleimide compound.

Such maleimide compound having active hydrogen is a maleimide compound having at least two active hydrogen atoms introduced by an intervening sulfide (—S—) bond at the terminal or the side chain of the molecule having the bismaleimide bond. This compound has characteristic features that the active hydrogen can take part in crosslinking reaction, and that the —S— bond is thermally dissociatable.

When the maleimide compound contains one molecule of the bismaleimide and two —S— bonds, the compound is represented by the following formula (4):

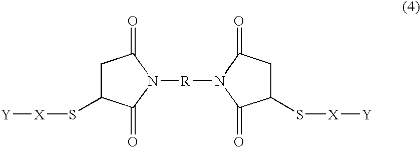

In the formula, R represents an optionally substituted noncyclic aliphatic group containing 1 to 24 carbon atoms, an optionally substituted cyclic aliphatic group containing 5 to 18 carbon atoms, an optionally substituted aromatic group containing 6 to 18 carbon atoms, or an optionally substituted alkyl aromatic group containing 7 to 24 carbon atoms, said group R optionally containing at least one hetero atom selected from the group consisting of SO₂, O, N, and S. X is an optionally substituted organic group containing 2 to 24 carbon atoms; and Y is a substituent selected from the group consisting of hydroxyl group, amino group, and carboxyl group. When the substituent is present, the substituent may be any substituent as long as the reaction of the present invention is not affected by the substituent.

Of the above-mentioned compounds having at least one thiol group and at least one substituent selected from the group consisting of hydroxyl group, amino group, and carboxyl group in one molecule used in producing the maleimide compound having active hydrogen, use of 2-mercaptoethanol, 2-amino-thiophenol, or thiosalicylic acid is preferable since these compounds are inexpensive and easy to handle. More preferably, the compound having at least one thiol group and at least one substituent selected from the group consisting of hydroxyl group, amino group, and carboxyl group in one molecule is an aromatic thiol or a heterocyclic thiol having at least one substituent as described above in one molecule since use of such thiol is effective in making use of the thermal dissociation property as will be described below, and more specifically, the compound is preferably 2-amino-thiophenol or thiosalicylic acid.

With regard to the bismaleimide compound, of the bismaleimide compounds mentioned above, use of 1,6-bismaleimide hexane, 1,2-bismaleimide ethane, or 4,4′-diphenylmethanebismaleimide is preferable for economic reason.

Typical maleimide compound having active hydrogen represented by the above formula (4) is obtained, for example, by reacting the compound having at least one thiol group and at least one substituent selected from the group consisting of hydroxyl group, amino group, and carboxyl group in one molecule with the bismaleimide compound as described below. The maleimide compound having active hydrogen represented by the above formula (4) is not limited to the one obtained by such reaction.

The reaction is preferably carried out by adding 2 equivalents of the compound having at least one thiol group and at least one substituent selected from the group consisting of hydroxyl group, amino group, and carboxyl group in one molecule to the bismaleimide compound, and stirring the mixture, either in the absence or in the presence of an organic solvent, at room temperature to 100° C. for 1 to 24 hours. The organic solvent may be any organic solvent as long as both the bismaleimide compound and the compound having at least one thiol group and at least one substituent selected from the group consisting of hydroxyl group, amino group, and carboxyl group in one molecule are soluble in the solvent, and more specifically, the organic solvent may be any solvent mentioned for the second preferred embodiment of the present invention. The preferred solvents are also the same as those described for the second preferred embodiment.

After the completion of the reaction, the mixture is concentrated by removing the organic solvent under a reduced pressure to obtain the maleimide compound having active hydrogen represented by the above formula (4).

In this reaction, R is determined by the structure of the above-described bismaleimide compound. For example, when the bismaleimide compound is 1,6-bismaleimide hexane, R in the above formula (4) is hexyl group, and when the bismaleimide compound is N,N′-1,4-phenylenedimaleimide, R in the above formula (4) will be phenyl group. Accordingly, the maleimide compound wherein R in the above formula (4) is the particular group as described above is preferably obtained by reacting the bismaleimide compound having an optionally substituted noncyclic aliphatic group containing 1 to 24 carbon atoms, an optionally substituted cyclic aliphatic group containing 5 to 18 carbon atoms, an optionally substituted aromatic group containing 6 to 18 carbon atoms, or an optionally substituted alkylaromatic group containing 7 to 24 carbon atoms with the compound having at least one thiol group and at least one substituent selected from the group consisting of hydroxyl group, amino group, and carboxyl group in one molecule.

In the above formula (4), X represents an optionally substituted organic group containing 2 to 24 carbon atoms, and X preferably contains at least one hetero atom selected from the group consisting of SO₂, O, N, and S. The term organic group used herein designates an alkyl group, a cycloalkyl group or an aryl group which is optionally substituted with at least one atomic group selected from the group consisting of a cycloalkyl group, an alkoxyl group, a cycloalkoxy group, an aryl group, an aryloxy group, an alkanoyloxy group, an aralkyloxy group, and a halogen atom. The organic group is preferably an aliphatic hydrocarbon group, an aromatic group, heterocyclic group, or a substituent formed by combination of these groups. Among these, the organic group is preferably either an aromatic group or a heterocyclic group for the convenience of thermal dissociation. When the organic group has a substituent, the substituent may be any substituent as long as the reaction of the present invention is not affected by the substituent. The preferred, however, are an alkyl group and a halogen group. Y is preferably hydroxyl group, amino group, or carboxyl group.

In this reaction, X and Y are determined by the compound having at least one thiol group and at least one substituent selected from the group consisting of hydroxyl group, amino group, and carboxyl group in one molecule. Accordingly, when X in the above formula (4) should be an aromatic group or a heterocyclic group, an aromatic thiol or a heterocyclic thiol is used as described above for the compound having at least one thiol group and at least one substituent selected from the group consisting of hydroxyl group, amino group, and carboxyl group in one molecule. When Y in the above formula (4) should be hydroxyl group, amino group, or carboxyl group, a compound having hydroxyl group, amino group, or carboxyl group is used as described above for the compound having at least one thiol group and at least one substituent selected from the group consisting of hydroxyl group, amino group, and carboxyl group in one molecule.

In view of the situation as described above, examples of the maleimide compounds represented by the formula (4) include the compounds represented by the following formulae (12) to (15), and the preferred are the compounds represented by formulae (13) and (15). It is to be noted that, of the compounds represented by the following formulae (12) to (15), those represented by the formulae (14) and (15) correspond to those which were synthesized in the Examples 5 and 6.

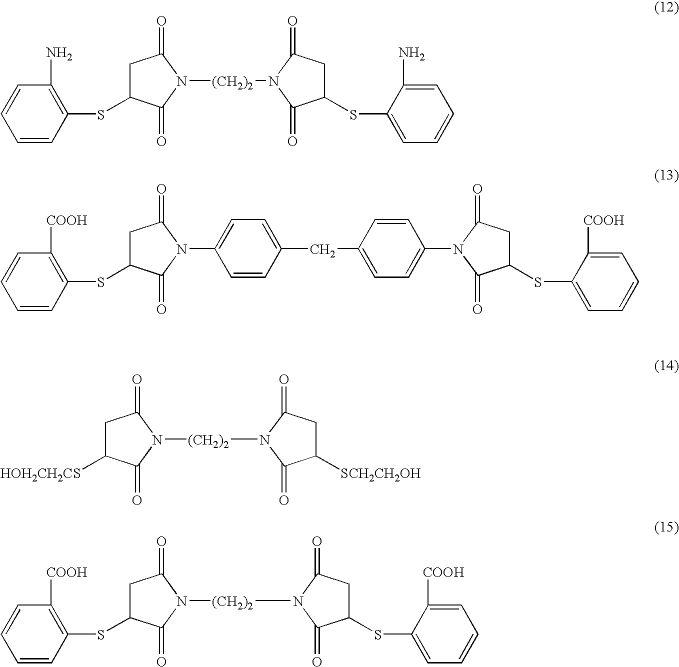

The present invention also provides a curable composition containing the maleic acid derivative as described above and a compound (polymer) which has a group capable of reacting with the maleic acid derivative. In these curable composition, the maleic acid derivative of the present invention functions as a curing agent. The maleic acid derivative in the curable composition generally includes those obtained by reacting a compound having at least one thiol group in the molecule and a maleic acid compound, and includes all of the maleic acid derivatives of the first preferred embodiment represented by formulae (1) and (2), the thiol compounds of the second preferred embodiment, and the maleimide compounds having active hydrogen of the third preferred embodiment.

Accordingly, the functional group capable of reacting with the maleic acid derivative differs depending on the maleic acid derivative used in the curable composition. For example, when the composition contains the maleic acid derivative represented by the above formula (1) or (2), typical functional group capable of reacting with the maleic acid derivative may be amino group, hydroxyl group, thiol group, epoxy group, carbonate group, oxazoline group, or an alkoxysilane group. Therefore, the compounds capable of reacting with the maleic acid derivative represented by the above formula (1) or (2) are the compounds containing at least one functional group selected from the group consisting of amino group, hydroxyl group, thiol group, epoxy group, carbonate group, oxazoline group, and an alkoxysilane group in the molecule.

To be more specific, the curable composition containing the maleic acid derivative represented by the above formula (1) or (2) preferably contains a compound containing epoxy group, a compound containing amino group, or a compound containing hydroxyl group as the compound containing the functional group capable of reacting with the maleic acid derivative. Among these, use of a compound containing epoxy group, and in particular, use of epoxy resin is preferable since use of such compound is effective in making use of the thermal dissociation property as will be described below.

When the curable composition contains the thiol compound of the second preferred embodiment, typical functional group capable of reacting with the thiol compound are isocyanate group, epoxy group, carbonate group, ester group, vinyl group, oxazoline group, and maleic group. Accordingly, typical compounds capable of reacting with the thiol compound are compounds containing at least one functional group selected from the group consisting of isocyanate group, epoxy group, carbonate group, ester group, vinyl group, oxazoline group, and maleic group in the molecule.

To be more specific, the compound containing a functional group capable of reacting with thiol compound used is preferably a compound containing epoxy group or a compound containing isocyanate group since use of such compound is effective in making use of the thermal dissociation property as will be described below. The compound containing epoxy group used is preferably bis A epoxy resin, and the compound containing isocyanate group used is preferably urethane prepolymer.

When the curable composition contains the maleimide compound of the third preferred embodiment, typical functional group capable of reacting with the maleimide compound are epoxy group, isocyanate group, carbonate group, silyl group, ester group, and oxazoline group. Accordingly, typical compounds capable of reacting with the maleimide compound are compounds containing at least one functional group selected from the group consisting of epoxy group, isocyanate group, carbonate group, silyl group, ester group, and oxazoline group in the molecule.

To be more specific, the compound containing a functional group capable of reacting with the maleimide compound used is preferably a compound containing epoxy group, a compound containing isocyanate group, a compound containing carbonate group, a compound containing silyl group, a compound containing ester group, or a compound containing oxazoline group since use of such compound is effective in making use of the thermal dissociation property as will be described below. Among these, the compound containing epoxy group is preferably bis A epoxy resin, and the compound containing isocyanate group is preferably urethane prepolymer. It also to be noted that the curable composition is not thermally dissociatable when amine functions as the bifunctional group as in the case of the curable composition containing epoxy group and amino group, while the curable composition is thermally dissociatable as will be described below when the curable composition contains isocyanate group and amino group. Therefore, in the case of the compound containing epoxy group, Y in the above formula (4) is preferably carboxyl group, and when urethane prepolymer is used, Y is preferably hydroxyl group or amino group.

Since the curable composition containing the compound capable of reacting with the maleic acid derivative, the thiol compound, or the maleimide compound cures by reacting with the maleic acid derivative in the broad sense including these compounds, it may preferably have a weight average molecular weight of 100 to 1,000,000, and more preferably, 100 to 500,000.

In the curable composition containing the maleic acid derivative in the broad sense and the compound capable of reacting with the maleic acid derivative, the maleic acid derivative functions as a curing agent, and cured product can be obtained either in the absence of catalyst, or in the presence of a tertiary amine catalyst. However, when the maleic acid derivative is the maleic acid derivative of the first preferred embodiment, the composition is reacted in the presence of a tertiary amine catalyst.

For the reaction, adequate ranges of curing temperature, curing time, and ratio of the maleic acid derivative to the compound capable of reacting with the maleic acid derivative are selected depending on the type of the maleic acid derivative and the compound capable of reacting with the maleic acid derivative used.

For example, when the maleic acid derivative is the maleic acid derivative of the first preferred embodiment, and the compound capable of reacting with the maleic acid derivative is epoxy resin, the curing temperature is preferably in the range of room temperature to 150° C., and the curing time is preferably in the range of 10 to 120 minutes. As will be shown in the Examples, the reaction is promoted such that the functional group of the maleic acid derivative is 0.5 to 1.5 equivalents, and preferably, 0.7 to 1.3 equivalents in relation to the epoxy equivalent of the epoxy resin.

When the maleic acid derivative is the thiol compound of the second preferred embodiment, and the compound capable of reacting with the thiol compound is epoxy resin, the curing temperature is preferably in the range of 50 to 150° C., and the curing time is preferably in the range of 1 to 100 minutes. As will be shown in the Examples, the reaction is promoted such that the functional group of the thiol compound is 0.5 to 1.5 equivalents, and preferably, 0.7 to 1.3 equivalents in relation to the epoxy equivalent of the epoxy resin.

When the maleic acid derivative is the maleimide compound of the third preferred embodiment, and the compound capable of reacting with the maleimide compound is urethane prepolymer, the curing temperature is preferably in the range of room temperature to 160° C., and the curing time is preferably in the range of 10 to 240 minutes. As will be shown in the Examples, the reaction is promoted such that the active hydrogen of the maleimide compound is 0.5 to 2.0 equivalents, and preferably, 0.7 to 1.3 equivalents in relation to the isocyanate equivalent of the urethane prepolymer.

The tertiary amine catalysts may be a monoamine, a diamine, a triamine, a polyamine, a cyclic amine, an alcoholic amine, an ether amine, or the like, and examples of such tertiary amine catalyst include triethylamine, N,N-dimethylcyclohexylamine, N,N,N′,N′-tetramethylethylene-diamine, N,N,N′,N′-tetramethylpropane-1,3-diamine, N,N,N′,N′-tetramethylhexane-1,6-diamine, N,N,N′,N″,N″-pentamethyldiethylenetriamine, N,N,N′,N″,N″-pentamethyl-dipropylenetriamine, tetramethylguanidine, N,N-dipolyoxyethylenestearylamine, N,N-dipolyoxyethylene tallow alkylamine, triethylenediamine, N,N′-dimethylpiperadine, N-methyl-N′-(2-dimethylamino)-ethylpiperadine, N-methylmorpholine, N-ethylmorpholine, N-(N′,N′-dimethyl-aminoethyl)morpholine, 1,2-dimethylimidazol, dimethyl-aminoethanol, dimethylaminoethoxyethanol, N,N,N′-trimethylaminoethylethanolamine, N-methyl-N′-(2-hydroxy-ethyl)piperadine, N-(2-hydroxyethyl)morpholine, bis(2-dimethylaminoethyl)ether, ethyleneglycol bis(3-dimethyl)aminopropylether, and 2,4,6-tris(dimethylamino-methyl)phenol, which may be used in combination of two or more.

The cured product has an advantageous feature that it becomes thermally dissociatable and disassembly of it become possible when it is reheated to a temperature higher than the temperature of the curing reaction, namely, when the product is reheated preferably to a temperature of 150 to 250° C. when the maleic acid derivative is the maleic acid derivative of the first preferred embodiment or the maleimide compound of the third preferred embodiment, and to a temperature of 150 to 250° C., and more preferably to a temperature of 160 to 200° C. when the maleic acid derivative is the thiol compound of the second preferred embodiment. The thermal dissociation time is preferably in the range of 1 to 60 minutes, and more preferably 1 to 30 minutes irrespective of the type of the maleic acid derivative.

Such thermal dissociation is generated by the thermal dissociation that occurs in the moiety of the maleic acid derivative in the cured product. Therefore, when the maleic acid derivative is used for the curing agent in producing the cured product of epoxy resin, polycarbonate, urethane prepolymer, and the like which traditionally had no thermal dissociatability, the curing agent will provide the resulting cured product with the thermal dissociatability. In particular, since epoxy resin has the highly reactive epoxy group on its terminal as well as the adequately dispersed hydroxyl group, and it can undergo various chemical reactions by such functional groups, and also, since epoxy resin has high bond strength due to the high density and toughness of the hydroxyl group, use of the maleic acid derivative of the present invention as a curing agent with the epoxy resin which has excellent mechanical properties is quite favorable.

When the curable composition of the present invention is used for a sealant or an adhesive composition, an inorganic filler or a plasticizer may be blended with the curable composition of the present invention.

The inorganic filler is blended for the purpose of cost reduction, improvement of physical properties, and viscosity adjustment. The type and amount of the filler used should be determined with care since storage stability, curing speed, physical properties, and foaming are all significantly affected by the activity of the filler with isocyanate group, shape of the particles, pH, whether surface has been treated or not, and the like. The fillers generally used are calcium carbonate, talc, silica, carbon black, and the like. A plasticizer may be used for adjusting viscosity and physical properties. Any plasticizer that is inactive with isocyanate group and that does not bleed with the reason of having a good compatibility may be used, and the placticizers generally used include dioctyl phthalate, dibutyl phthalate, dioctyl adipate, and the like.

The sealant containing the curable composition as described above may be used as a construction material or as a sealant for double glazing.

The curable composition of the present invention may comprise a curing catalyst, a filler other than those describe above, a thixotropic agent, a pigment, a dye, an antiaging agent, an antioxidant, an antistatic, a frame retardant, a tackifier, a dispersing agent, or a solvent in addition to the critical components as described above to the extent that the merits of the present invention is not impaired.

### EXAMPLES

Next, the present invention is described in further detail by referring to Examples, which by no means limit the scope of the present invention.

### Examples 1 to 3

Examples 1 to 3 are directed to curable compositions containing a maleic acid derivative according the first preferred embodiment. In Table 1 are shown equivalent ratio of the functional group of the components in the curable composition, curing temperature and curing time, and thermal dissociation temperature and thermal dissociation time.

### Example 1

To 200 g of methyl ethyl ketone were added 27.2 g (0.1 mole) of 2-di-n-butylamino-4,6-dimercapto-s-triazine and 19.6 g (0.2 mole) of maleic anhydride, and the mixture was reacted at 70° C. for 3 hours. After the completion of the reaction, methyl ethyl ketone was removed at a reduced pressure at 90° C. to produce 46.8 g (yield, 100%) of maleic acid derivative (Compound 1) represented by the following formula (5).

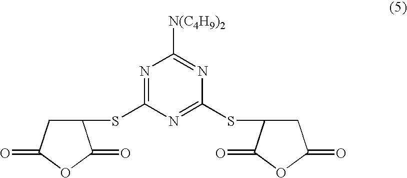

2.34 g of the resulting maleic acid derivative (Compound 1) and 1.9 g of bis A epoxy resin were mixed in a flask, and 0.04 g of 2,4,6-tris(dimethylaminomethyl)phenol (product name: DMP30, manufactured by Kayaku Akzo Corporation) was added as a tertiary amine. The resulting composition lost its surface and inner tack and became cured after heating in an oven of 80° C. for 30 minutes.

After the production of the cured product, the product was heated again in an oven at 160° C. The product then underwent thermal dissociation, and disassembly of the product became possible in 10 minutes.

### Example 2

To 200 g of methyl ethyl ketone were added 15.0 g (0.1 mole) of 1,3,4-thiadiazole-2,5-dithiol and 19.6 g (0.2 mole) of maleic anhydride, and the mixture was reacted at 70° C. for 3 hours. After the completion of the reaction, methyl ethyl ketone was removed at a reduced pressure at 90° C. to produce 34.6 g (yield, 100%) of the maleic acid derivative (Compound 2) represented by the following formula (6).

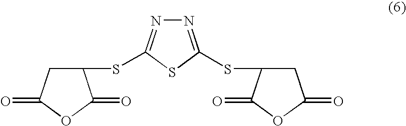

1.74 g of the resulting maleic acid derivative (Compound 2) and 1.9 g of bis A epoxy resin were mixed in a flask, and 0.04 g of 2,4,6-tris(dimethylaminomethyl)phenol (product name: DMP30, manufactured by Kayaku Akzo Corporation) was added as a tertiary amine. The resulting composition lost its surface and inner tack and became cured after heating in an oven of 100° C. for 60 minutes.

After the production of the cured product, the product was heated again in an oven at 180° C. The product then underwent thermal dissociation, and disassembly of the product became possible in 10 minutes.

### [Example 3

To 200 g of methyl ethyl ketone were added 27.2 g (0.1 mole) of 2-di-n-butylamino-4,6-dimercapto-s-triazine and 34.4 g (0.2 mole) of monobutyl maleate, and the mixture was reacted at 70° C. for 3 hours. After the completion of the reaction, methyl ethyl ketone was removed at a reduced pressure at 90° C. to produce 61.6 g (yield, 100%) of maleic acid derivative (Compound 3) represented by the following formula (7).

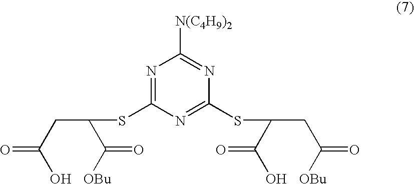

2.8 g of the resulting maleic acid derivative (Compound 3) and 1.39 g of trimethylolpropane polyglycidylether (product name: ED-505R, manufactured by Asahi Denka Co., Ltd.) as a trifunctional epoxy resin were mixed in a flask, and 0.04 g of 2,4,6-tris (dimethylaminomethyl)phenol (product name: DMP30, manufactured by Kayaku Akzo Corporation) was added as a tertiary amine. The resulting composition lost its surface and inner tack and became cured after heating for 30 minutes in an oven of 80° C.

After the production of the cured product, the product was heated again in an oven at 180° C. The product then underwent thermal dissociation, and disassembly of the product became possible in 10 minutes.

TABLE 1

| | Example 1 | Example 2 | Example 3 |
|---|---|---|---|
| Equivalent ratio of | | | |
| functional groups | | | |
| Compound 1 | 80 | | |
| Compound 2 | | 80 | |
| Compound 3 | | | 80 |
| Bis A epoxy resin | 100 | 100 | |
| Trifunctional epoxy | | | 100 |
| (ED-505R) | | | |
| Tertiary amine | 2 | 2 | 2 |
| (DMP-30) | | | |
| Curing temperature/ | 80° C./ | 100° C./ | 80° C./ |
| time | 30 min. | 60 min. | 30 min. |
| Thermal dissociation | 160° C./ | 180° C./ | 180° C./ |
| temperature/time | 10 min. | 10 min. | 10 min. |

### Example 4 and Comparative Example 1

Example 4 is directed to a curable composition containing a thiol compound according the second preferred embodiment. Comparative Example 1 is a comparative example for this Example 4. In Table 2 are shown equivalent ratio of the functional group of the components in the curable composition, curing temperature and curing time, and thermal dissociation temperature and thermal dissociation time.

### Example 4

To 100 g of methyl ethyl ketone were added 27.2 g (0.1 mole) of 2-di-n-butylamino-4,6-dimercapto-s-triazine and 11.1 g (0.05 mole) of 1,2-bismaleimide ethane, and the mixture was reacted at 90° C. for 5 hours. After the completion of the reaction, methyl ethyl ketone was removed at a reduced pressure at 90° C. to produce 20.2 g (reaction yield, 100%) of maleimide compound (Compound 4) represented by the following formula (11). The Compound 4 produced was a mixture of the compounds wherein n in the formula was an integer of 1 to 3.

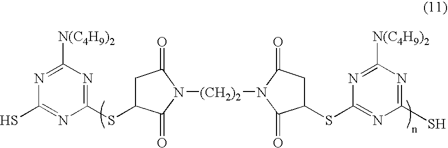

3.8 g of the resulting maleimide compound (Compound 4) and 1.4 g of trimethylolpropane polyglycidylether (product name: ED-505R, manufactured by Asahi Denka Co., Ltd.) as a trifunctional epoxy resin were mixed in a flask, and 0.04 g of 2,4,6-tris(dimethylaminomethyl)phenol (product name: DMP30, manufactured by Rohm and Haas Company) was added as a tertiary amine. The resulting composition lost its surface and inner tack and became cured after heating in an oven of 100° C. for 30 minutes.

After the production of the cured product, the product was heated again in an oven at 160° C. The product then underwent thermal dissociation, and disassembly of the product became possible in 10 minutes.

### Comparative Example 1

1.4 g of 2-di-n-butylamino-4,6-dimercapto-s-triazine (Compound 5) and 1.4 g of trimethylolpropane polyglycidylether (product name: ED-505R, manufactured by Asahi Denka Co., Ltd.) as a trifunctional epoxy resin were mixed in a flask, and 0.04 g of 2,4,6-tris(dimethylaminomethyl)phenol (product name: DMP30, manufactured by Rohm and Haas Company) was added as a tertiary amine. The resulting composition lost its surface and inner tack and became cured after heating in an oven of 120° C. for 60 minutes.

After the production of the cured product, the product was heated again in an oven at 160° C. The product, however, did not become thermally dissociated.

TABLE 2

| | | Comparative |
|---|---|---|
| | Example 4 | Example 1 |
| Equivalent ratio of | | |
| functional groups | | |
| Compound 4 | 100 | |
| Compound 5 | | 100 |
| Trifunctional epoxy (ED- | 100 | 100 |
| 505R) | | |
| Tertiary amine (DMP-30) | 2 | 2 |
| Curing temperature/ | 100° C./30 min | 120° C./60 min |
| time | | |
| Thermal dissociation | 160° C./10 min | 160° C./30 min |
| temperature/time | | Not dissociated |

### Examples 5 and 6

Examples 5 and 6 are directed to a curable composition containing a maleimide compound according the third preferred embodiment. In Table 3 are shown equivalent ratio of the functional group of the components in the curable composition, curing temperature and curing time, and thermal dissociation temperature and thermal dissociation time. The urethane prepolymer used was the one synthesized by blending trifunctional polypropylene glycol (PPG) and TDI at the (isocyanate group/hydroxyl group) ratio of 2.5. The PPG had a mass average molecular weight of 3,000.

### Example 5

To 100 g of methyl ethyl ketone were added 9.2 g (0.1 mole) of 2-mercaptoethanol and 11.0 g (0.05 mole) of 1,2-bismaleimide ethane, and the mixture was reacted at 90° C. for 5 hours. After the completion of the reaction, methyl ethyl ketone was removed at a reduced pressure at 90° C. to produce 20.2 g (yield, 100%) of maleimide compound (Compound 6) represented by the following formula (14).

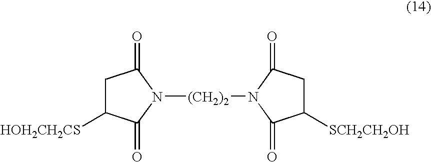

3.6 g of the resulting maleimide compound (Compound 6) and 10 g of urethane prepolymer were mixed in a flask, and 0.24 g of 2,4,6-tris(dimethylaminomethyl)phenol (product name: DMP-30, manufactured by Rohm and Haas Company) was added as a tertiary amine. The resulting composition lost its surface and inner tack and became cured after heating in an oven of 100° C. for 30 minutes.

After the production of the cured product, the product was heated again in an oven at 180° C. The product then underwent thermal dissociation, and disassembly of the product became possible in 10 minutes.

### [Example 6

To 100 g of methyl ethyl ketone were added 15.4 g (0.1 mole) of thiosalicylic acid and 11.0 g (0.05 mole) of 1,2-bismaleimide ethane, and the mixture was reacted at 80° C. for 2 hours. After the completion of the reaction, methyl ethyl ketone was removed at a reduced pressure at 80° C. to produce 26.5 g (yield, 100%) of maleimide compound (Compound 7) represented by the following formula (15).

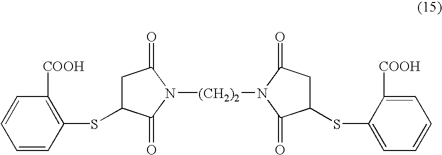

2.9 g of the resulting maleimide compound (Compound 7) and 1.4 g of trimethylolpropane polyglycidylether (product name: ED-505R, manufactured by Asahi Denka Co., Ltd.) as a trifunctional epoxy resin were mixed in a flask, and 0.028 g of 2,4,6-tris(dimethylaminomethyl)phenol (product name: DMP-30, manufactured by Rohm and Haas Company) was added as a tertiary amine. The resulting composition lost its surface and inner tack and became cured after heating in an oven of 100° C. for 60 minutes.

After the production of the cured product, the product was heated again in an oven at 170° C. The product then underwent thermal dissociation, and disassembly of the product became possible in 10 minutes.

TABLE 3

| | Example 5 | Example 6 |
|---|---|---|
| Equivalent ratio of | | |
| functional groups | | |
| Compound 6 | 100 | |
| Compound 7 | | 100 |
| Urethane prepolymer | 100 | |
| Trifunctional epoxy (ED-505R) | | 100 |
| Tertiary amine (DMP-30) | 2 | 2 |
| Curing temperature/time | 100° C./30 min. | 100° C./60 min. |
| Thermal dissociation | 180° C./10 min. | 170° C./10 min. |
| temperature/time | | |

### Industrial Applicability

As described above, when the maleic acid derivative of the present invention is used as a curable composition, the maleic acid derivative functions as a curing agent in the curing reaction, and in addition, controls thermal dissociation of the cured product. This enables fast disassembly of the cured product in a reduced time, and the curable composition is highly useful as a plastic material which is excellent in waste disposal and other properties.

1. A maleic acid derivative produced by reacting a compound having at least one thiol group in one molecule, and a maleic acid compound.

2. A maleic acid derivative represented by the following formula (1) or (2): 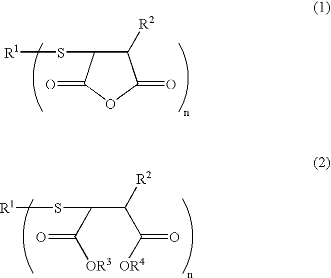
wherein n is an integer of 1 to 10; R¹ is an optionally substituted organic group containing 2 to 20 carbon atoms; R² is an optionally substituted alkyl group containing 2 to 10 carbon atoms, hydrogen atom, or a halogen atom; R³ and R⁴ are independently an optionally substituted alkyl group containing 2 to 20 carbon atoms or hydrogen atom.

3. A thiol compound produced by reacting a compound having at least two thiol groups in one molecule and a bismaleimide compound.

4. A thiol compound represented by the following formula (3): 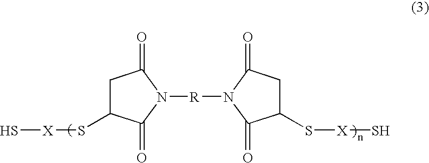
wherein n is an integer of 1 to 10; R is an optionally substituted noncyclic aliphatic group containing 1 to 24 carbon atoms, an optionally substituted cyclic aliphatic group containing 5 to 18 carbon atoms, an optionally substituted aromatic group containing 6 to 18 carbon atoms, or an optionally substituted alkyl aromatic group containing 7 to 24 carbon atoms, said group R optionally containing at least one hetero atom selected from the group consisting of SO₂, O, N, and S; and X is an optionally substituted organic group containing 2 to 24 carbon atoms.

5. A maleimide compound having active hydrogen produced by reacting a compound having at least one thiol group and at least one substituent selected from hydroxyl group, amino group, and carboxyl group in one molecule, and a bismaleimide compound.

6. A maleimide compound having active hydrogen represented by the following formula (4): 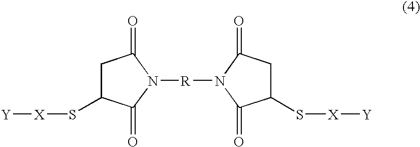
wherein R is an optionally substituted noncyclic aliphatic group containing 1 to 24 carbon atoms, an optionally substituted cyclic aliphatic group containing 5 to 18 carbon atoms, an optionally substituted aromatic group containing 6 to 18 carbon atoms, or an optionally substituted alkyl aromatic group containing 7 to 24 carbon atoms, said group R optionally containing at least one hetero atom selected from the group consisting of SO₂, O, N, and S; X is an optionally substituted organic group containing 2 to 24 carbon atoms; and Y is hydroxyl group, amino group, or carboxyl group.

7. A curable composition comprising at least one member selected from the maleic acid derivative of claim 1 or 2, the thiol compound of claim 3 or 4, and the maleimide compound of claim 5 or 6; and a compound having a functional group capable of reacting with said maleic acid derivative, said thiol compound, or said maleimide compound.

8. A curable composition according to claim 7 wherein said compound having a functional group capable of reacting with said maleic acid derivative has at least one functional group selected from amino group, hydroxyl group, thiol group, and epoxy group.

9. A curable composition according to claim 7 wherein said compound having a functional group capable of reacting with said maleic acid derivative is an epoxy resin having epoxy group or an epoxy-modified compound.

10. A curable composition according to claim 7 characterized in that said functional group capable of reacting with said thiol compound is at least one functional group selected from isocyanate group, epoxy group, carbonate group, ester group, vinyl group, oxazoline group, and maleic group.

11. A curable composition according to claim 7 characterized in that said functional group capable of reacting with said maleimide compound is at least one functional group selected from isocyanate group, epoxy group, maleic group, carbonate group, silyl group, ester group, and oxazoline group.

12. A curable composition according to claim 7 wherein cured product produced by curing said curable composition is thermally dissociatable.

13. A curable composition according to claim 8 wherein cured product produced by curing said curable composition is thermally dissociatable.
